(19) United States
(12) Patent Application Publication
(10) Pub. No.: US 2025/0085439 A1
(43) Pub. Date: Mar. 13, 2025

(54) Method for Determining Position in a Vehicle by Receiving GNSS Signals while Calibrating a GNSS Receiving Antenna based on a Plurality of Antenna Error Impact Maps

(71) Applicant: Robert Bosch GmbH, Stuttgart (DE)

(72) Inventors: Simon Weissenmayer, Flein (DE); Marco Limberger, Appenweier-Urloffen (DE); Sebastian Roith, Ludwigsburg (DE)

(21) Appl. No.: 18/816,234

(22) Filed: Aug. 27, 2024

(30) Foreign Application Priority Data
Sep. 11, 2023 (DE) 10 2023 208 740.5

(51) Int. Cl. G01S 19/39; G01S 19/23

(52) U.S. Cl. CPC G01S 19/393; G01S 19/235

(57) ABSTRACT

A method is disclosed for determining position in a vehicle by receiving GNSS signals while calibrating a GNSS receiving antenna based on a plurality of different antenna error impact maps stored in the vehicle. The method includes (a) determining at least one signal parameter of at least one GNSS signal, (b) selecting at least two antenna error impact maps from the plurality of antenna error impact maps, (c) determining at least one correction value to correct a position determination from each of the at least two selected antenna error impact maps while taking into account the signal parameter determined in step (a), and (d) performing the position determination with a Kalman filter, wherein corrective values determined in step (c) are taken into account.

This application claims priority under 35 U.S.C. § 119 to patent application no. DE 10 2023 208 740.5, filed on Sep. 11, 2023 in Germany, the disclosure of which is incorporated herein by reference in its entirety.

### BACKGROUND

The present disclosure relates to a method for determining position in a vehicle by receiving GNSS signals while calibrating a GNSS receiving antenna based on a plurality of antenna error impact maps stored in the vehicle. Also disclosed are a control unit, a computer program and a machine-readable storage medium. The disclosure can particularly be used in GNSS-based localization systems for autonomous or semi-autonomous driving.

A global navigation satellite system (Abbrev.: GNSS) has a number of GNSS satellites that move around the earth and emit electromagnetic GNSS signals. By receiving GNSS signals with an antenna, a vehicle can be positioned and navigated.

When receiving GNSS signals with the antenna, it must be considered that group delay variations or antenna error impacts as a function of azimuth angles and elevation angles to GNSS satellites may affect the measurement accuracy (e.g., the accuracy of the time-of-flight measurement) of GNSS signals. In other words, this means that the measurement accuracy of GNSS signals is dependent on the relative position between the antenna and the corresponding GNSS satellites.

In addition to the group delay variations and the azimuth angles and elevation angles, the measurement accuracy of GNSS signals may be additionally affected by the vehicle body surface, because different paint types, paint colors, dirt and/or weather conditions (e.g. wet paint in the rain, snow-covered paint in the snow), can have different reflectance and attenuation properties, such that GNSS signals may be reflected through the vehicle body surface upon being received (especially a vehicle body with silver metallic paint) and/or attenuated (especially a snow-covered vehicle roof).

In the context of automated travel functions that are critical for safety, the positioning accuracy must be within the centimeter range. Thus, there is a desire to account for and compensate for the above-mentioned negative impacts in the calculation of the navigation solutions (e.g., position, speed, time).

Proceeding therefrom, the object of the present disclosure is to alleviate or at least partially solve the problems described in relation to the prior art. In particular, a method shall be disclosed for determining position in a vehicle by receiving GNSS signals under calibration of GNSS receiving antennas while taking into account vehicle characteristics, particularly vehicle body surfaces. This is particularly important for autonomous driving, because autonomous driving places particularly high demands on the accuracy of the navigation solutions.

### SUMMARY

This is achieved with a method for determining position in a vehicle by receiving GNSS signals while calibrating a GNSS receiving antenna based on a plurality of different antenna error impact maps stored in the vehicle, wherein the following steps are performed:
a) determining at least one signal parameter of at least one GNSS signal;
b) selecting at least two antenna error impact maps from the plurality of antenna error impact maps;
c) determining at least one correction value to correct a position determination from each of the at least two selected antenna error impact maps taking into account the signal parameter determined in step a); and
d) performing the position determination with a Kalman filter, wherein corrective values determined in step c) are considered.

As mentioned above, the measurement accuracy of GNSS signals is dependent on many factors. Significant factors are, for example, azimuth angles and elevation angles of the respective GNSS satellites (i.e., the relative positions between an antenna and the GNSS satellites) but also atmospheric influences, reflections and deflections of GNSS signals, etc. It has been found that the measurement accuracy of GNSS signals also depends on vehicle characteristics (e.g., different paints), and in particular there is also a dependence on the orientation of the vehicle in space (i.e., on the azimuth angles and elevation angles). Depending on how a vehicle is oriented relative to the present GNSS satellite configuration, different signal deviations occur that result in erroneous or postponed positioning/position determinations. With the proposed method, the measurement of GNSS signals and the position determination with the measured GNSS signals can be done taking into account azimuth angles and elevation angles (relative to vehicle orientation and antenna orientation, respectively) as well as taking into account vehicle characteristics so that the positioning accuracy and also the overall performance of the GNSS-based navigation can be improved. The vehicle characteristics are taken into account as a function of signal parameters, wherein signal parameters in this context are particularly azimuth angles and elevation angles.

In preparation for the proposed method, a plurality of different antenna error impact maps may be generated from various vehicle characteristics by, for example, determining measurement errors of GNSS signals with differently painted vehicles on a rotary plate. With the rotation of the rotary plate, the measurement errors can be determined for different azimuth angles and elevation angles and the determined measurement errors for the corresponding azimuth angles and elevation angles can be entered into an antenna error impact map. Among the different vehicle characteristics, the measurement errors determined at the same azimuth angles and elevation angles may also be of different magnitudes. These measurement error magnitude differences are possibly (only) caused by the different vehicle characteristics, however, because the measurement errors are determined at the same azimuth angles and elevation angle among the different vehicle characteristics. Thus, the antenna impact maps used herein may be so distinct from one another that the measurement errors entered on the different antenna impact maps may be of different magnitudes, although these measurement errors are associated with the same azimuth angles and elevation angles.

In order for the measurement of GNSS signals while driving a vehicle to be performed correctly while also taking into account vehicle characteristics, it is essential to use at least two different antenna impact maps which may be different from one another. Preferably, the at least two different antenna impact maps each depict maximum possible errors or a particularly extreme filter in a given situation (for certain azimuth angles and elevation angles). Thus, a real measured value of a GNSS signal with measurement errors may be corrected, from which at least two different antenna error impact maps were created for the same azimuth angles and elevation angles of the GNSS satellite emitting the GNSS signal.

For example, the measured values of GNSS signals are the time-of-flight of GNSS signals from the corresponding GNSS satellites to the GNSS receiving antenna. Furthermore, based on the measured time-of-flight times and the speed of light, the distances between the GNSS satellites and the GNSS receiving antennas may be calculated. Accordingly, the antenna error impact maps proposed herein may comprise the time-of-flight and/or ranging errors associated with the azimuth angles and elevation angles.

The vehicle characteristics relevant to the measurement accuracy of GNSS signals are in particular the vehicle body surface, which have different paint types, different paint colors and/or different amounts of dirt and can reflect and/or attenuate the GNSS signals in different ways, such that the GNSS signals may be received with a longer or shorter time-of-flight, and time-of-flight measurement errors and the ranging errors can occur. In addition, the vehicle body surface may also have different reflectance and/or dampening characteristics under different weather conditions due to the wetness/snow adhering thereto. For example, in rain, a vehicle body surface with wet paint may affect the GNSS signals more strongly than a vehicle body surface with dry paint due to reflection. In situations where snow has fallen on the vehicle, a vehicle body surface with snow-covered paint and a snow-covered vehicle roof may affect the GNNS signals more strongly than a snow-free vehicle body surface and vehicle roof.

Generally, the time-of-flight and/or ranging errors caused by azimuth angles and elevation angles and vehicle characteristics are part of the so-called “systematic errors” (i.e., not random errors) and may occur regularly according to a deterministic pattern under certain circumstances. It is thus possible to experimentally ascertain such time-of-flight and/or ranging errors in advance and correct the currently measured time-of-flight times and/or distances with the predetermined time-of-flight and/or ranging errors when the vehicle is driven.

It may be contemplated that the predetermined time-of-flight and/or ranging errors may be presented in the form of an antenna error impact map. Such an antenna error impact map can be stored in a control unit. As a result, the measured time-of-flight times and/or the calculated distances or the determined positions/position determinations can be corrected with the time-of-flight and/or ranging errors read from the antenna error impact map while the vehicle is traveling. The control unit may be a control unit of a GNSS localization system, with which the vehicle is equipped.

According to step a), at least one signal parameter of at least one GNSS signal is determined. The signal parameter is, for example, the azimuth and elevation angle of the GNSS satellite emitting this GNSS signal. It is possible, for example, to determine, from the ephemerides included in the received GNSS signal, from which GNSS satellite the received GNSS signal comes and how/where this GNSS satellite is currently in the sky. Furthermore, with the current direction of travel of the vehicle determined by the sensor technology (e.g., IMU sensor technology) and/or the camera, it is thus possible to determine the azimuth and elevation angle from the GNSS receiving antenna of the vehicle with respect to the GNSS satellite emitting the received GNSS signal.

According to step b), at least two antenna error impact maps are selected from the plurality of antenna error impact maps. It is possible to select only two extreme antenna error impact maps having the greatest differences with respect to each other. For example, an extreme antenna error impact map may be selected to be pre-created with a silver metallic vehicle, while another extreme antenna error impact map may be selected to be pre-created with a black matte vehicle. It has been found that precisely this combination of antenna error impact maps (silver vehicle and black matte vehicle) each captures particularly extreme error impacts. Thus, the currently measured GNSS signals can only be corrected using these two extreme antenna error impact maps. This is particularly advantageous because it allows the computer resources (e.g., computing time, memory requirement) to be reduced to a minimum. It is also conceivable to select more than two antenna error impact maps so that the measured GNSS signals can be corrected with more than two selected antenna error impact maps. This is particularly advantageous to further improve the accuracy of the overall navigation solution.

According to step c), at least one correction value for correcting a position determination is determined from each of the at least two selected antenna error impact maps, taking into account the signal parameter determined in step a). At this point, the signal parameter serves as a bridge connecting a real measurement value with a predetermined measurement error as a correction value. This correction value may be, for example, the time-of-flight measurement error of a GNSS signal or the ranging error calculated from the time-of-flight measurement error with the speed of light between the corresponding GNSS satellite and the GNSS receiving antenna, while the signal parameter determined in step a) is the azimuth and elevation angle of the corresponding GNSS satellite. To this end, according to the azimuth and elevation angle determined in step a), the time-of-flight measurement error and/or ranging error associated with that azimuth and elevation angle may be read from the respective antenna impact maps selected in step b). The read time-of-flight measurement errors and/or ranging errors are used in step d) for position determining.

Preferably, a correction value is determined for each GNSS signal considered. Correction values determined from an antenna error impact map are also referred to herein as a “set” of correction values. Preferably, for each GNSS signal used for a position determination, correction values are determined with each of the at least two antenna error impact maps, depending on the respective signal parameter (in particular as a function of the respective azimuth angles and elevation angles relative to the vehicle). Thus, for a set of GNSS signals used for a position determination, preferably after step c), there are more sets of correction values (based on the individual antenna error impact maps).

According to step d), the position determination is made with a Kalman filter comprising fusion of data corrected and/or estimated with the correction values determined in step c).

The conventional Kalman filter performs essentially two tasks or performs two different determinations. The Kalman filter makes predictions of expected readings in a next (future) time interval. The Kalman filter fuses predicted readings with the real readings to determine the position to be output to the vehicle.

For the use of the correction values determined according to step c) for the positioning determination, two different approaches are proposed here.

According to a first option, in step d) correction values from different antenna error impact maps are used together in the Kalman filter for position determination.

According to a second option, in step d) with a Kalman filter, initial positions are first determined for each antenna error impact map selected in step b) separately from one another and then initial positions are fused to a position to be output.

In the first option, the various antenna error impact maps are considered together for positioning in the Kalman filter. In principle, correction values (each from the particularly extreme antenna error impact maps) are adjusted and then the corrected readings are fused to the predicted readings to determine the position to be output.

For example, in the second option, for each of the correction values determined in step c), a corresponding initial position is first estimated, and then the estimated initial positions are fused to the position to be output. Fusion of the initial positions to the output position may also be performed outside of the Kalman filter, for example, in which the output position forms a center position.

With the described method, the measurement errors caused by the vehicle body surface may be compensated purely at the software level without hardware effort, without the need to replace the GNSS receiving antennas (e.g., vehicle antennas) already existing in the vehicles with, for example, highly precise, geodetic antennas. The compensation of such measurement errors is particularly advantageous for autonomous driving where positioning accuracy in the centimeter range is required.

It is also preferred if the initial positions are weighted using probability values and a position to be output is averaged from the weighted initial positions.

The initial positions and the position to be output have the same time stamp. The initial positions are estimated only internally. The position to be output is the final determined position and is sent to the vehicle from the GNSS control unit. The initial positions are only the estimated possible positions. A position to be output may be fused, averaged, and/or weighted from a plurality of initial positions, wherein each initial position is estimated with a correction value determined from a selected antenna error impact map.

The estimated initial positions are preferably weighted using probability values, and the position to be output is averaged from the weighted initial positions.

Alternatively, if the estimated initial positions do not strongly deviate from one another, the position to be output may be averaged directly from the initial positions (i.e., without weighting).

It is preferred when the initial positions are weighted using likelihood values and a position to be output is averaged from the weighted initial positions. The following sub-steps can be carried out:
estimating initial positions,
determining residues using real readings,
determining likelihood values using the residues and using measurement covariances, and
determining a position to be output averaged from the initial positions, wherein the initial positions are weighted using the likelihood values.

It is preferred when the weighting of the initial positions is filtered using a PT1 filter with a time constant. The time constant may be at least 30 seconds.

It is preferred that the time constant is optimized using machine learning.

It is preferred that at least one signal parameter comprises the receiving direction of a GNSS signal.

It is preferred that the vehicle characteristics include at least the vehicle body surface.

It is preferred if the antenna error impact maps were created with the following steps:
i) providing a vehicle having a GNSS receiving antenna and a particular vehicle body surface on a rotatable plate,
ii) measuring GNSS signals with the GNSS receiving antenna while rotating the rotary plate,
iii) determining measurement errors based on the measured GNSS signals
iv) creating an antenna error impact map representing the measurement errors determined in step iii) as a function of different receiving directions, and
v) repeating steps i) to iv) for creating a plurality of antenna error impact maps for vehicles having different vehicle body surfaces.

It is also preferred if, in step v), the antenna error impact maps were created taking into account different weather conditions, wherein the weather conditions are simulated with snow-covered paint, wet paint or dry paint.

Because receipt of GNSS signals may be affected by the relative positions between the GNSS receiving antenna and the respective GNSS satellites, according to step i), a vehicle with a GNSS receiving antenna is provided on a rotatable plate.

As the plate rotates, the vehicle rotates with it. With theodolite measurements, the different orientations of the vehicle and the different true positions and receiving directions of the GNSS receiving antenna can be determined while rotating the vehicle.

According to step ii), GNSS signals are measured with the GNSS receiving antenna. In particular, the time-of-flight of the GNSS signals between the GNSS receiving antenna and the respective GNSS satellites are measured.

According to step iii), measurement errors are determined between the measured values and the true values. The measurement errors are, for example, the time-of-flight measurement error or the ranging error calculated with the time-of-flight measurement error. The true values can be determined using known methods, such as based on the ephemerides of the respective GNSS satellites.

According to step iv), the measurement errors detected during rotation in different receiving directions are entered according to the corresponding receiving directions in an antenna error impact map. On the antenna error impact map, the different receiving directions may be represented by the corresponding azimuth angles and elevation angles.

As mentioned above, vehicle body surfaces having different coating types and/or colors may have different effects on receipt of GNSS signals with the vehicle antenna. In addition, receipt of GNSS signals may be affected by the coating being covered with a little or a lot of snow, wetness, and/or dirt.

Thus, according to step v), different antenna impact maps may be created with different vehicles, wherein each is of the same vehicle model but has different body surfaces. The body surfaces may differ from one another in at least one of: coating type, color, snow, wetness and dirt.

Preferably, the body surfaces are selected such that the body surfaces differ as much from each other as possible in their reflectance and/or attenuation properties in order to detect as many extreme measurement errors of GNSS signals as possible through the measurements, which can then be further processed in the form of extreme antenna impact maps. The determined extreme measurement errors may represent the limits that the real measurement errors are not to exceed while traveling. Thus, the real measurement errors of GNSS signals during travel are typically between the determined extreme measurement errors so that the real measurement errors or real measured values can be compensated or corrected by mathematical methods such as interpolation, fusion, averaging, and/or weighting.

For example, in the simplest case, an antenna error impact map may be created with a silver metallic wet vehicle, which may contain extreme measurement errors due to the extreme reflection (compared to other colors). In contrast, another antenna error impact map may be created with a matte black, dry vehicle that may contain extreme measurement errors due to extreme dampening (compared to other colors). During travel, the two extreme antenna error impact maps may be used to correct the current readings.

It is preferable if a control unit is installed to carry out the described method.

It is additionally preferred if a computer program is used to carry out a method described here. In other words, this relates in particular to a computer program (product) comprising commands which, when the program is executed by a computer, prompt said computer to perform a method described herein.

It is also preferable if a machine-readable storage medium is used, on which the computer program proposed herein is stored. The machine-readable storage medium is typically a computer-readable data carrier.

The disclosure and the technical environment are explained in further detail hereinafter with reference to FIG. 1. It should be noted that FIG. 1 is schematic in nature. It should also be noted that the features shown in FIG. 1 do not necessarily have to be used in the presented combination; partial features can rather be extracted and combined with other explanations in the description. Anything different is intended to apply only when explicitly referred to herein as a mandatory combination of features.

### BRIEF DESCRIPTION OF THE DRAWINGS

FIG. 1 schematically illustrates two exemplary antenna error impact maps 1, 2, each created with a differently painted vehicle.

### DETAILED DESCRIPTION

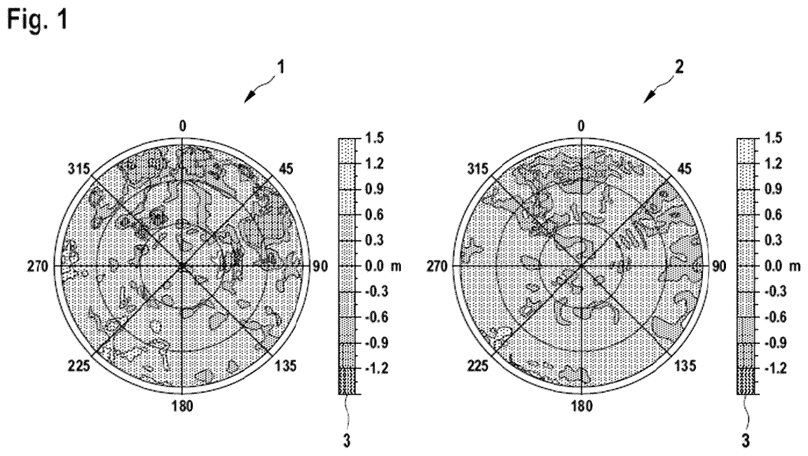

In FIG. 1, it can be seen that the relative positions between the vehicle or vehicle antenna and the respective GNSS satellites are represented by a circle with angles of between 0 degrees and 360 degrees. For example, the center of the circle describes a GNSS satellite located exactly above the vehicle or vehicle antenna. The intersection of the diameter with the circumference of the circle at 90 degrees describes that a GNSS satellite is directly above horizontal on the right side of the vehicle. The intersection of the diameter with the circumference of the circle at 0 degrees describes that a GNSS satellite is directly above horizontal in the direction of travel from the vehicle.

It can further be seen in FIG. 1 that the two antenna error impact maps 1, 2 may have different ranging errors 3 at the same locations. For example, the first antenna error impact map 1 shows that the ranging error 3 in the lower left region between 180 and 270 degrees is much greater (almost over 1 meter) than the ranging error 3 in the same range of the second antenna error measurement map 2. These differences are possibly caused by the different paints. During travel, the two antenna impact maps 1, 2 may be used to correct real readings, in which, according to the relative positions between the vehicle antenna and the GNSS satellites, the affected ranging errors are read from the two antenna error impact maps 1, 2. The relative positions can be described in various known forms, such as with the angles shown in FIG. 1, for example, on the vehicle coordinate system or the azimuth angles and elevation angles on an astronomical coordinate system or the receiving directions. By using these two antenna error impact maps 1, 2, the measurement of GNSS signals and the determination of position with the measured GNSS signals can be achieved, both by taking into account relative positions and taking into account vehicle characteristics, particularly paint, so that the positioning accuracy and also the overall performance of GNSS-based navigation can be improved.

What is claimed is:

1. A method for determining position in a vehicle by receiving GNSS signals while calibrating a GNSS receiving antenna based on a plurality of different antenna error impact maps stored in the vehicle, comprising:
a) determining at least one signal parameter of at least one GNSS signal;
b) selecting at least two antenna error impact maps from the plurality of antenna error impact maps;
c) determining at least one correction value to correct a position determination from each of the at least two selected antenna error impact maps while taking into account the signal parameter determined in step a); and
d) performing the position determination with a Kalman filter while taking into account the correction values determined in step c).

2. The method according to claim 1, wherein:
in step d), correction values from different antenna error impact maps are used together in the Kalman filter for position determination.

3. The method according to claim 1, wherein:
in step d), with a Kalman filter, initial positions for each antenna error impact map selected in step b) are first determined separately from each other and then initial positions are fused to a position to be output.

4. The method according to claim 3, wherein the initial positions are weighted using probability values, and the position to be output is averaged from the weighted initial positions.

5. The method according claim 4, wherein the initial positions are weighted using likelihood values, and the position to be output is averaged from the weighted initial positions.

6. The method according to claim 3, wherein the weighting of the initial positions is filtered using a PT1 filter with a time constant.

7. The method according to claim 6, wherein the time constant is optimized using machine learning.

8. The method according to claim 1, wherein the at least one signal parameter determined in step a) and considered in step c) comprises the receiving direction of a GNSS signal.

9. The method according to claim 1, wherein the vehicle characteristics comprise at least the vehicle body surface.

10. The method according to claim 1, wherein the antenna error impact maps were created with the steps of:
i) providing a vehicle having a GNSS receiving antenna and a particular vehicle body surface on a rotary plate,
ii) measuring GNSS signals with the GNSS receiving antenna while rotating the rotary plate,
iii) determining measurement errors based on the measured GNSS signals,
iv) creating an antenna error impact map representing the measurement errors determined in step iii) as a function of different receiving directions, and
v) repeating steps i) to iv) for creating a plurality of antenna error impact maps for vehicles having different vehicle body surfaces.

11. The method according to claim 10, wherein:
in step v), the antenna error impact maps are created taking into account different weather conditions, and
the weather conditions are simulated with snow-covered paint, wet paint or dry paint.

12. The method according to claim 1, wherein:
in step b), two antenna error impact maps are selected having the greatest differences from one another.

13. A control unit, which is configured to carry out a method according to claim 1.

14. A computer program for performing a method according to claim 1.

15. A machine-readable storage medium on which the computer program according to claim 14 is stored.
